(19) United States
(12) Patent Application Publication
(10) Pub. No.: US 2013/0174058 A1
(43) Pub. Date: Jul. 4, 2013

(54) System and Method to Automatically Aggregate and Extract Key Concepts Within a Conversation by Semantically Identifying Key Topics

(71) Applicant: SPRYLOGICS INTERNATIONAL CORP., Concord (CA)

(72) Inventors: Bhavuk Kaul, San Francisco, CA (US); Aleksandar Zivkovic, North York (CA); Bradley Michael Marks, Toronto (CA); Marvin Igelman, Thornhill (CA)

(73) Assignee: SPRYLOGICS INTERNATIONAL CORP., Concord (CA)

(21) Appl. No.: 13/734,051

(22) Filed: Jan. 4, 2013

Related U.S. Application Data
(60) Provisional application No. 61/583,091, filed on Jan. 4, 2012.

(51) Int. Cl. G06F 3/0481

(52) U.S. Cl. CPC G06F 3/0481
USPC 715/753

(57) ABSTRACT

Methods are provided for providing a user with real-time access to supplemental information about named entities that appear within a conversation in a messaging application on a user terminal. Named entities, conversational topics, and sentiments are recognized as the user enters messages into the application. These are provided to a semantic search engine in a server system, that classifies the named entities into one of a variety of domains. Each domain has an associated tool for retrieving detailed supplemental information about the named entity. The server system transmits, to the user terminal, indicia that allow the user terminal to retrieve the supplemental information. Advertising related to a named entity having favorable sentiment also may be transmitted to the user terminal for display. These functions occur without the need for a separate search interface in the messaging application.

### CROSS-REFERENCE TO RELATED APPLICATION

This application claims the benefit of U.S. Provisional Application No. 61/583,091 filed Jan. 4, 2012, the entire contents of which are incorporated herein by reference.

### FIELD OF THE INVENTION

The present invention relates to providing a user terminal with a list of entities and/or objects extracted from a messaging conversation. The invention further relates to an enhanced messaging method which selectively displays a list of entities or objects and a device and computer readable medium for same.

### BACKGROUND

User terminals, such as smart phones and tablet computers, permit the exchange of text messages and imagery through messaging applications. FIG. 1 represents a user terminal 10 executing a messaging application as known in the art. The user terminal 10 pictured is a smart phone, and the messaging application is a simple text message application having a graphical user interface (GUI) 11. A conversation is depicted between two users who are represented by their initials “BK” and “AZ”. They are discussing a number of things, including where and when to eat dinner, what restaurant to patronize, and a recent sporting event. One of the messages from user “BK” is shown with reference number 12, and one of the messages from user “AZ” is shown with reference number 13. This conversation includes a number of named entities; that is, words and phrases having designators (names) that can be readily classified into a conceptual hierarchy (ontology). For example, the named entity “Pizza Hut” 14 is the name of a restaurant, as is “Papa John's” 15. Similarly, “Pasadena” 16 and “Sherman Oaks” 17 are names of cities in southern California.

As can be seen from the example of FIG. 1, messaging applications typically are designed to operate on user terminals that have limited resources such as available electrical power, memory space, and processing capability. Therefore, while these applications may provide an optimal chat experience, other features are often limited or omitted entirely. For example, the ability to search chat histories, if implemented at all, is often cumbersome and restricted to keyword searching. Also, if one of the participants in a conversation wants to search for supplemental information related to the conversation, such as the address of a restaurant, another application must be launched, during which time the conversation may progress unobserved.

### BRIEF SUMMARY OF EMBODIMENTS OF THE INVENTION

Illustrative embodiments of the present invention address the above problems by providing a real-time semantic search of messaging conversations, and display of supplemental information related to any identified concepts. By using a semantic search, synonyms and words similar to a given named entity are found, providing an advantage over prior art keyword searching. Moreover, using the algorithms explained in detail below, named entity recognition, topic identification, and sentiment analysis may be performed to provide supplemental information in the context of the conversation graphical environment. To provide better scalability and response time, and to enhance the privacy of users, these algorithms have been designed to execute under the limited resources of a user terminal, so that only their sanitized results are sent to a central server for further processing. Various embodiments may perform these functions without a separate search interface, providing an enjoyable user experience.

Therefore, there is provided in a first embodiment a computerized method of transmitting contextual information, from a server system toward a user terminal, the user terminal executing a messaging application having a graphical user interface. The method requires three computer processes executing on the server system. The first process is determining, from data pertaining to a conversation of the messaging application, a named entity, a topic, and a sentiment that each pertain to at least one message of the conversation. The second process is identifying supplemental information that pertains to a combination of one or more of the determined named entity, topic, and sentiment. The third process is transmitting the named entity and indicia pertaining to the identified supplemental information, from the server system toward the user terminal for display of the indicia on the user terminal by the messaging application using the graphical interface.

There is also provided an embodiment from the perspective of the user terminal for searching after a conversation has been concluded. This embodiment is a computerized method of displaying contextual information on a user terminal executing a messaging application having a graphical user interface. This method includes five computer processes executing on the user terminal. The first process is determining, from data pertaining to a conversation of the messaging application, a named entity, a topic, and a sentiment that each pertain to at least one message of the conversation. The second process is transmitting the determined named entity, topic, and sentiment to a server system. The third process is receiving from the server system indicia identifying supplemental information that pertains to the determined named entity, the server having determined the supplemental information as a function of the transmitted named entity, the topic, and the sentiment. The fourth process is displaying the indicia on a display of the user terminal, by the messaging application using the graphical interface. The fifth process is, upon receiving a selection of an indicium associated with the named entity using the graphical interface, displaying the received supplemental information on the display of the user terminal, by the messaging application using the graphical interface.

Variations on these methods are also contemplated. For example, the user terminal may be a smart phone, a personal digital assistant, a tablet computer, or a laptop computer. The messaging application may be a bulletin board application, an email application, an instant messaging application, or an SMS application. Determining the named entity may include using one or more of a dictionary search, a regular expression match, and a first probabilistic model derived from a first machine learning algorithm. The first probabilistic model may be stored on the user terminal for use by the first computer process. The topic and sentiment may be determined simultaneously using a second probabilistic model derived from a second machine learning algorithm. The second probabilistic model may be stored on the user terminal for use by the first computer process. The second machine learning algorithm may be trained using a corpus of publicly-available messages that each identify a topic and a sentiment, respectively, using textual markings. For example, the corpus may be TWITTER messages, in which case the topic textual markings are hashtags, and the sentiment textual markings are emoticons. The supplemental information may be, for instance, a web document, a wiki article, a search suggestion, a movie listing, a sports score, information pertaining to a local business, weather information, product information, an audiovisual presentation, or advertising. The indicia may include at least one indicium comprising a text string that is associated with a URL. If so, in one embodiment the methods described may be extended by first receiving a selection of the text string using the graphical interface, then displaying, on the user terminal, data retrieved from the URL.

Using these methods, messages from and to user terminals are automatically reviewed, key facts are summarized, concepts and sentiment associated with the entities are identified inside a messaging conversation, and all parties are presented with the key facts, entities, and related supplemental information.

### BRIEF DESCRIPTION OF THE FIGURES OF THE DRAWING

The foregoing features of the invention will be more readily understood by reference to the following detailed description, when read with reference to the accompanying drawings, in which:

FIG. 1 represents a user terminal application as known in the prior art;

FIG. 2 represents the user terminal of FIG. 1 executing an application in accordance with an embodiment of the invention;

FIG. 3 represents the user terminal of FIG. 2 after a user selection to access supplemental information pertaining to the conversation;

FIG. 4 shows different users experiencing different advertisements displayed in an advertisement area of the display of their respective user terminals;

FIG. 5 represents an example of an email application running on a user terminal, as known in the prior art;

FIG. 6 represents an email application in accordance with one embodiment of the present invention;

FIG. 7A shows a system in accordance with one embodiment of the present invention;

FIG. 7B shows the server system of FIG. 7A in more detail;

FIG. 7C shows the user terminal of FIG. 7A in more detail;

FIG. 8 is a flowchart showing processes relevant to a server system that is implementing an embodiment of the invention;

FIG. 9 is a flowchart showing processes relevant to a user terminal that is implementing a second embodiment of the invention;

FIG. 10 shows processes relevant to named entity recognition;

FIG. 11 shows processes relevant to topic identification;

FIG. 12 shows processes relevant to sentiment analysis; and

FIG. 13 is a flowchart showing processes relevant to the determination of supplemental information.

### DETAILED DESCRIPTION OF SPECIFIC EMBODIMENTS

Illustrative embodiments of the present invention are directed to a method for providing a user with easy access to content during a messaging conversation (also referred to herein as a conversation) as well as display advertisements based on sentiments displayed inside a conversation. There is no known prior art displaying easy to browse entities such as names, places, events and other identified entities related to the content of a messaging conversation while inside a messaging conversation. Furthermore, known methods are not capable of providing advertising that is supplemental to a sentiment of the entity in this connection, while illustrative embodiments of the present invention are capable of doing so. For example, illustrative methods of the present invention may provide a user terminal with a listing of good restaurants in a particular area based on a sentiment such as “love pizza”, and not show an advertisement for a local pizza if a user types “hates pizza” or “allergic to pizza”.

Definitions. As used in this description and the accompanying claims, the following terms shall have the meanings indicated:

A “messaging application” is a computer program or collection of programs that is able to transmit, by and between a plurality of individuals, textual messages that are meaningful to the individuals. Messaging applications include, without limitation: bulletin board applications, email applications, instant messaging applications, and short messaging service (“SMS”) applications.

A “user terminal” or “terminal” is an electronic device that is configured to execute a messaging application. A user terminal may be, for example, a cell phone, a smart phone, a personal digital assistant, a tablet computer, a laptop computer, or a desktop computer.

A “messaging conversation” or “conversation” is a series of one or more topical messages transmitted between individuals using a messaging application.

An “entity” is a concept of potential interest to an individual, that is meaningful within the context of a topic of a messaging conversation. An entity may be one or more recognized words associated with an ontology, for example (and not by way of limitation): a person, people, place, event, product, domain url, e-mail, phone, address location, company, date, time, money, percent, airline name, airline flight number, holiday greetings, relations and other categories that are relevant to the subject matter and topical area or areas of a messaging conversation.

A “named entity” is an entity that has a well-defined name. For example, “the automotive company created by Henry Ford in 1903” is an entity, but it also has the rigid designators “Ford” and “Ford Motor Company” so it is a named entity. Many entities that appear in conversations are well-defined, but some, such as “this past June”, are not because resolution of their meanings requires additional context. If it is possible to provide additional context, for example that the year in which the messaging conversation took place is 2012, then the entity may be further defined as “June of 2012”, which is a named entity.

“Named entity recognition” (also known as “entity identification” and “entity extraction”) is a process that locates and classifies entities into predefined categories such as the names of persons, organizations, locations, expressions of times, quantities, monetary values, percentages, and other categories depending on the context.

A “sentiment” is a favorability, or polarity of an entity or a topic in a messaging conversation, and could be positive, negative or neutral. “Sentiment analysis”, also known as “opinion mining”, refers to the application of natural language processing, computational linguistics, and text analytics to identify and extract favorability information in one or more messaging conversations.

“Semantic search” is a process that seeks to determine searcher intent and the contextual meaning of terms as they appear in a searchable data space to determine related terms that may be found in a conversation. Semantic search generally produces more relevant results than a simple keyword or Boolean search.

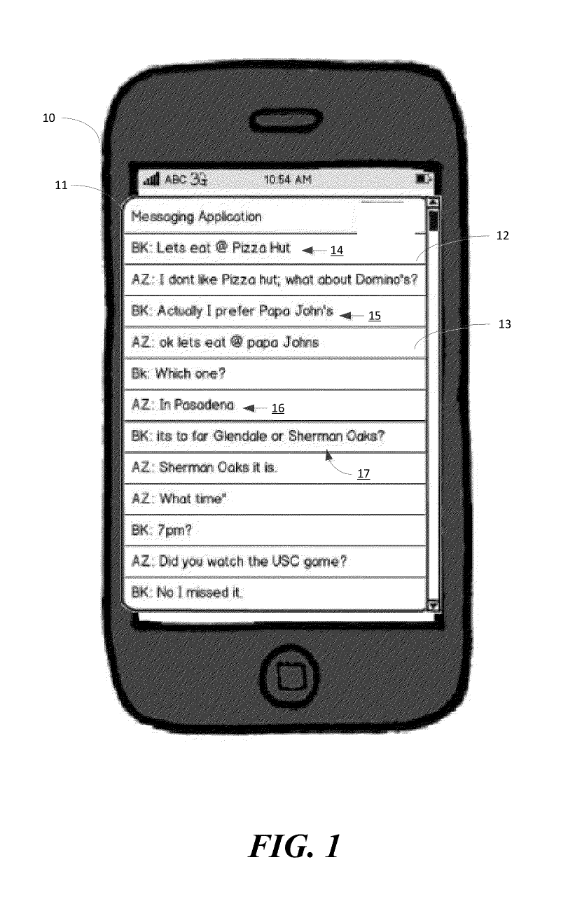

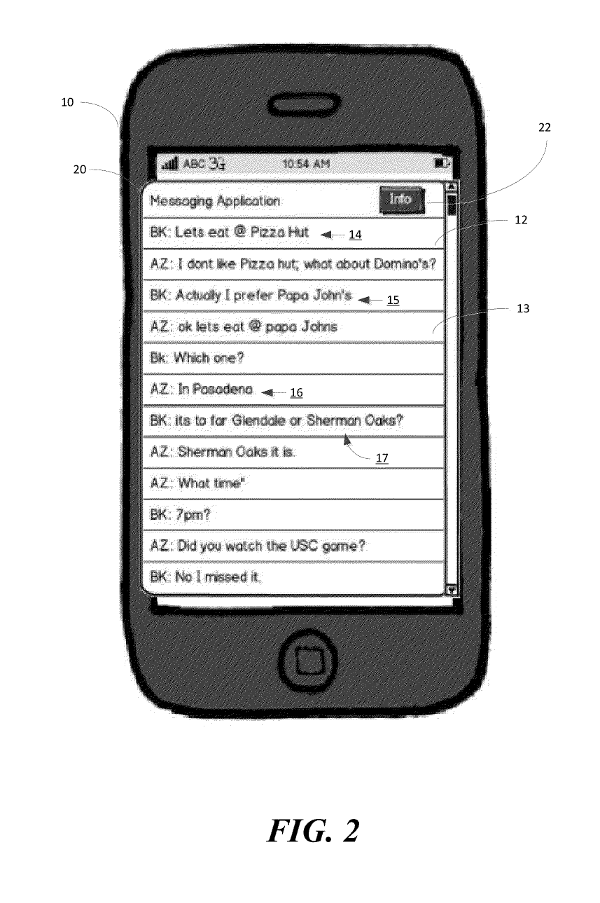

As discussed in the background, FIG. 1 represents a user terminal 10 executing an application as known in the prior art. FIG. 2 represents the user terminal 10 of FIG. 1 executing an application having a user interface 20 that is improved in accordance with an embodiment of the invention. The most visible improvement is the “Info” box 22. This box is provided in a convenient area of the graphical user interface (GUI) 20 of the messaging application. Clearly, different messaging applications will have different GUIs, and must therefore be provided with different implementations of the “Info” box 22; it is contemplated that this box 22 may be implemented in any convenient fashion. Selection of the “Info” box 22 results in the display in the GUI of indicia that represent supplemental information relevant to the named entities, while remaining within the application. The named entities and the supplemental information are determined by a named entity recognizer, described in more detail below, that may be executing either in the user terminal 10 or at another location. In one embodiment, the box 22 appears as a permanent feature of the GUI 20, while in other embodiments it may be enabled or disabled from an application settings control (not shown). It will be appreciated that other embodiments may provide access to the supplemental information in different ways, for example by directly converting named entities into hyperlinks in the messaging application, or otherwise providing access to the supplemental information in a logical and simple manner.

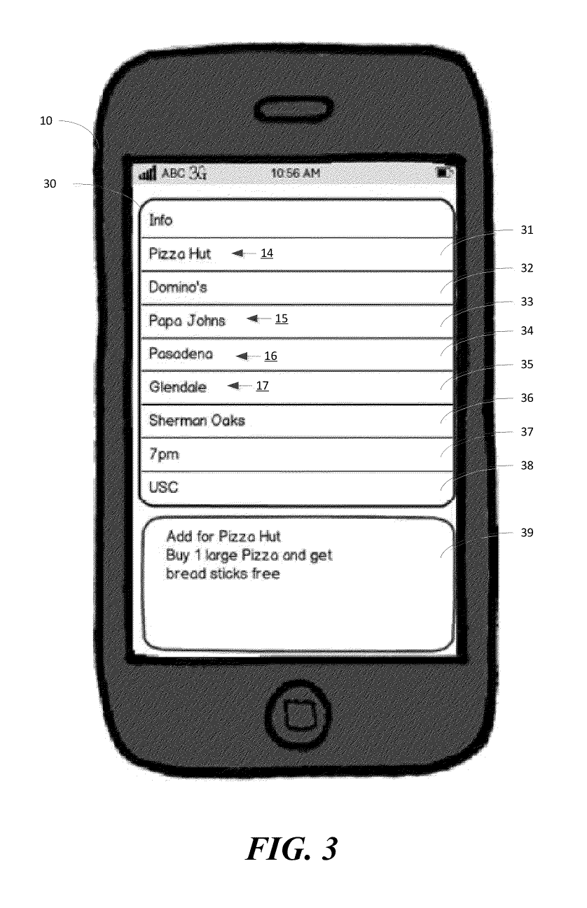

FIG. 3 represents the user terminal of FIG. 2 after a user selection to access supplemental information pertaining to the conversation. As can be seen from this Figure, the application presents a GUI 30 that includes selectable controls 31-38 that are labeled with indicia representing some of the named entities identified by the named entity recognizer. For example, the named entities 14-17 of FIG. 2 appear, as well as other named entities. The GUI 30 also includes a selectable advertisement control 39 that displays an advertisement as a function of a named entity and a positive or neutral sentiment. Selection of any one of the controls 31-39, for example by the user touching a touch screen, results in the supplemental information being displayed on the user terminal 10, using either the messaging application itself or an auxiliary program such as a web browser. It is known in the art how to cause a display of information in response to a user selection.

The indicia and advertisements that appear in the GUI 30 may be updated on a real-time basis by the named entity recognizer in cooperation with a topic extractor and a sentiment analyzer. That is, the named entities that are displayed in the GUI 30 are chosen by an embodiment as a function of the most recent messages in the conversation, because the execution of the named entity recognizer, topic extractor and sentiment analyzer is able to keep pace with an ongoing conversation as it occurs.

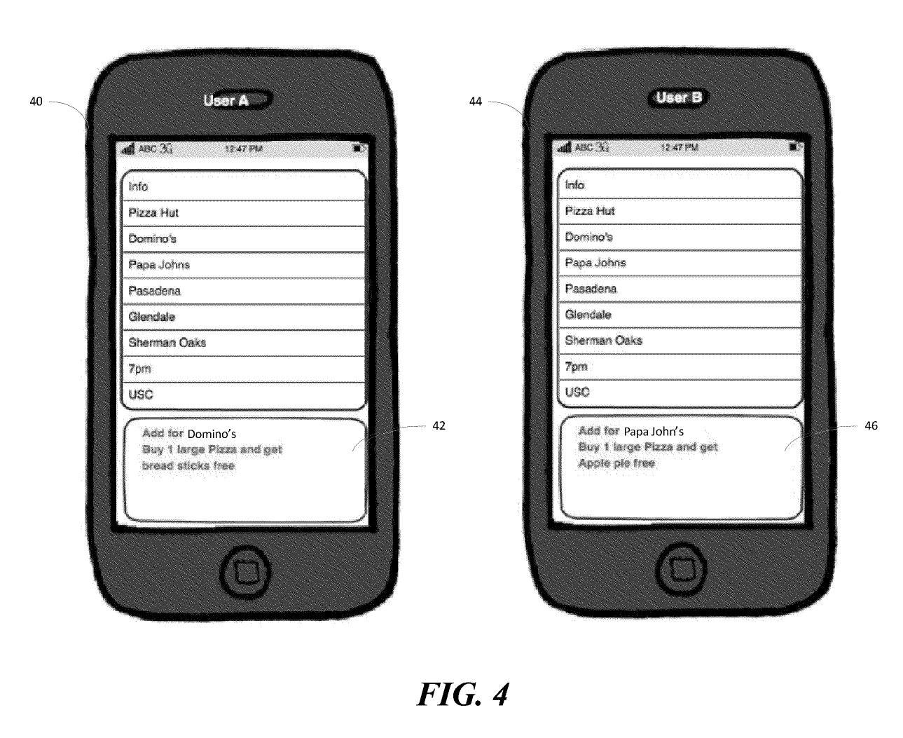

In accordance with another embodiment of the invention, different users may receive different advertisements. FIG. 4 illustrates this principle, in which a first User A has a user terminal 40 and a second User B has a user terminal 44. Consider, for example, that User A is the user “AZ” of FIG. 2 and User B is the user “BK” of that Figure. Because User A has expressed a preference for Domino's pizza, FIG. 4 shows a control 42 that displays to User A an advertisement for Domino's. Similarly, because User B has expressed a preference for Papa John's pizza, FIG. 4 shows a control 46 that displays to User B an advertisement for Papa John's. Implementation of this feature may be accomplished with the assistance of a sentiment analyzer, as described in more detail below.

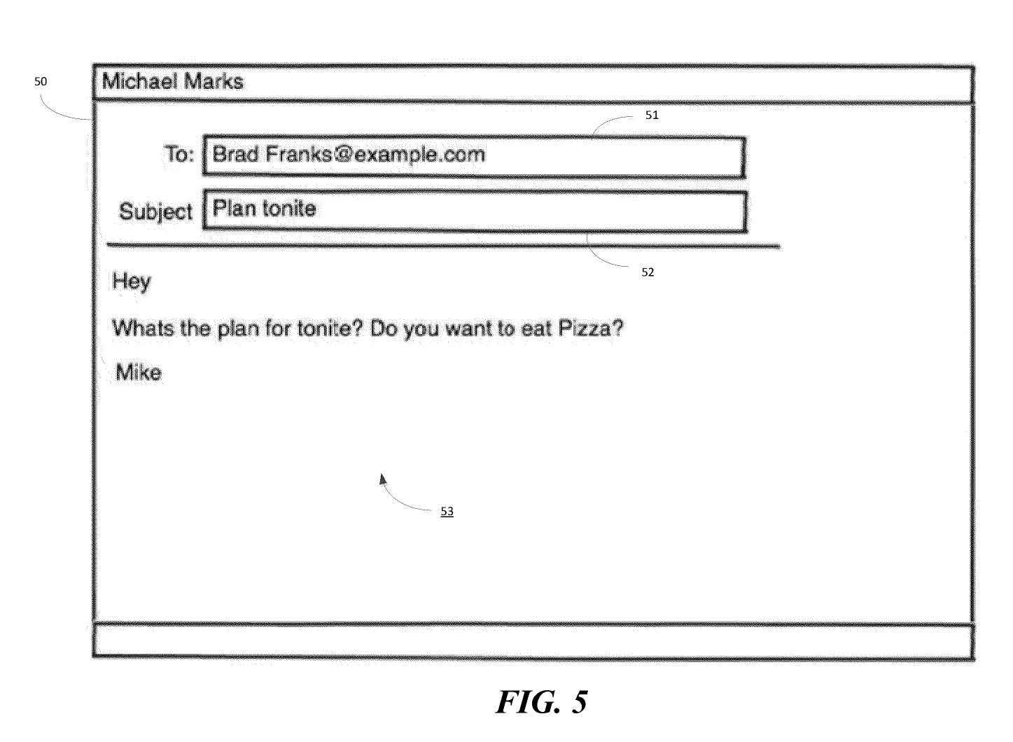

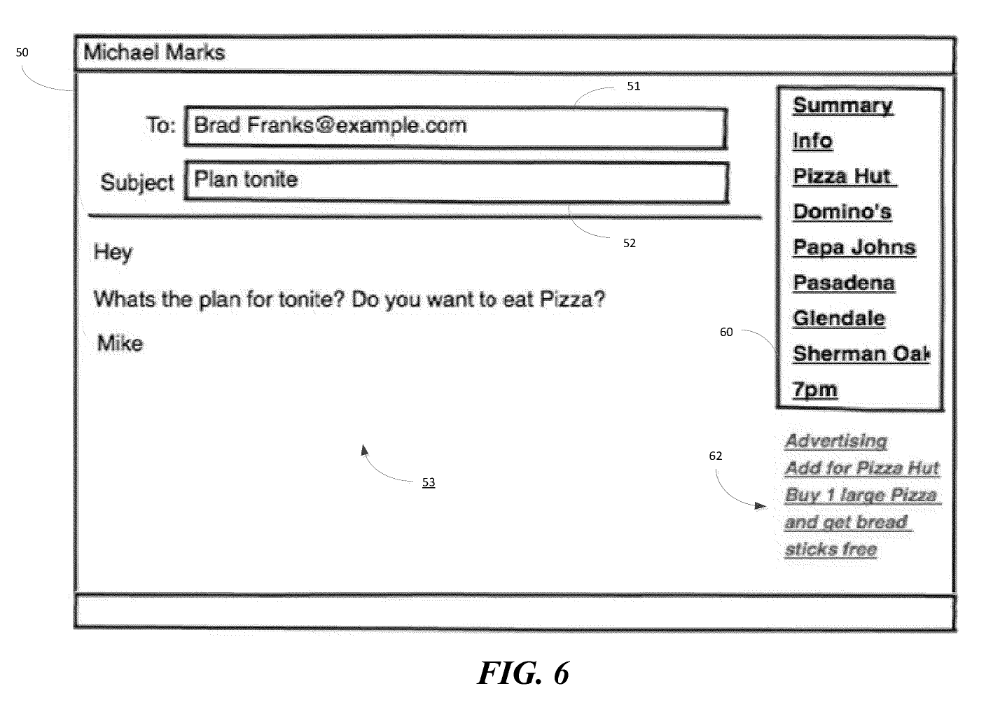

As another example of an improvement that is possible, FIGS. 5 and 6 respectively represent the GUIs of an email application as known in the prior art, and as improved in accordance with an embodiment of the invention. FIG. 5 shows a GUI 50 of an email application that has a recipient area 51, a subject area 52, and a message body area 53. FIG. 6 shows an improved GUI that includes an area 60 for displaying selectable named entities (in this case, selectable as hyperlinks) and an advertisement area 62 that shows an advertisement for Pizza Hut. In accordance with an email application embodiment such as that shown in FIG. 6, the selection of the named entities and the advertisement to be shown may be made by referencing other messages in an conversation (e.g., a chain of emails). Or, if the email is the first in a chain, the named entities for the single email may be extracted and cross-referenced with named entities (and their associated sentiments) of other, previous emails. As with the improvements to the instant messaging application described above, the named entity recognizer, topic extractor and sentiment analyzer may operate in real-time, so that named entities in area 60 and the advertisement(s) in area 62 are updated as the user enters their email message.

It will be understood that various embodiments of the invention may include indicia that represent the identified named entities using text, still images, moving images, or any other useful visual representations. It is also contemplated that the indicia may be vocalized or otherwise communicated to the user by audible means, for example by way of accessibility add-on software or hardware. As will be understood from the diverse nature of the above examples, any messaging application that has a GUI may be improved in accordance with embodiments of the present invention. Other arrangements that include additional elements (such as information regarding the conversation or search parameters) or omit various elements (such as the advertisement) are contemplated.

Various embodiments of the invention perform the above-identified functions in a number of different circumstances. In one embodiment, the functions are executed as a conversation is occurring. In this way, supplemental information pertaining to the ongoing conversation may be conveniently accessed in real-time. In another embodiment, the processes are executed after the conversation has concluded. Thus, a search may be performed to locate supplemental information about a named entity that the user remembers discussing only vaguely (so that the user does not have enough specific information to formulate an effective query in another search engine). For example, the user may remember that she is supposed to meet a friend at a restaurant, but doesn't remember which restaurant. This embodiment advantageously allows her to search for the restaurant, even if the word “restaurant” does not appear in any conversation.

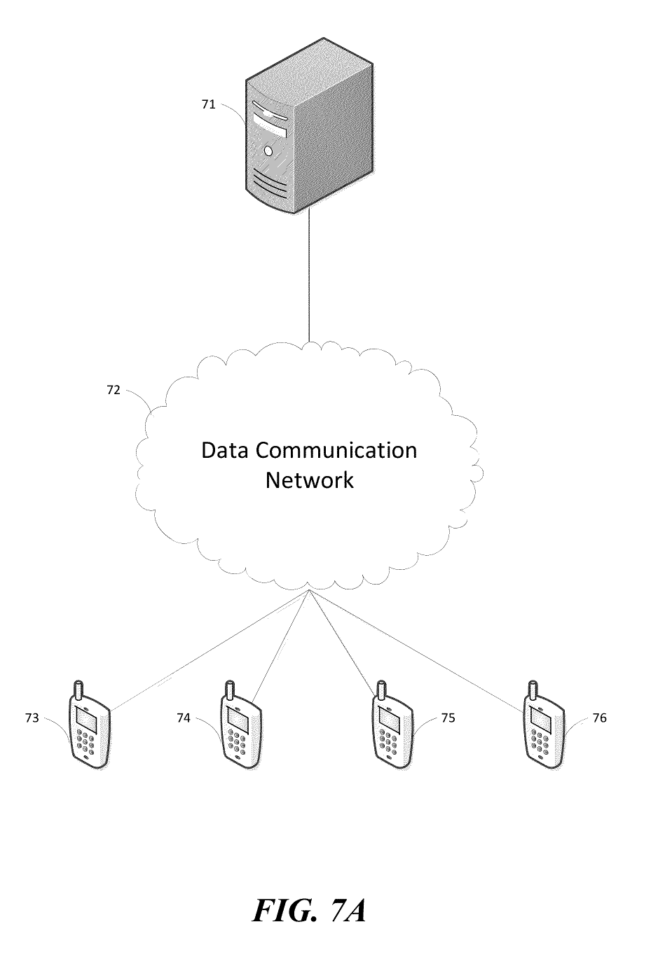

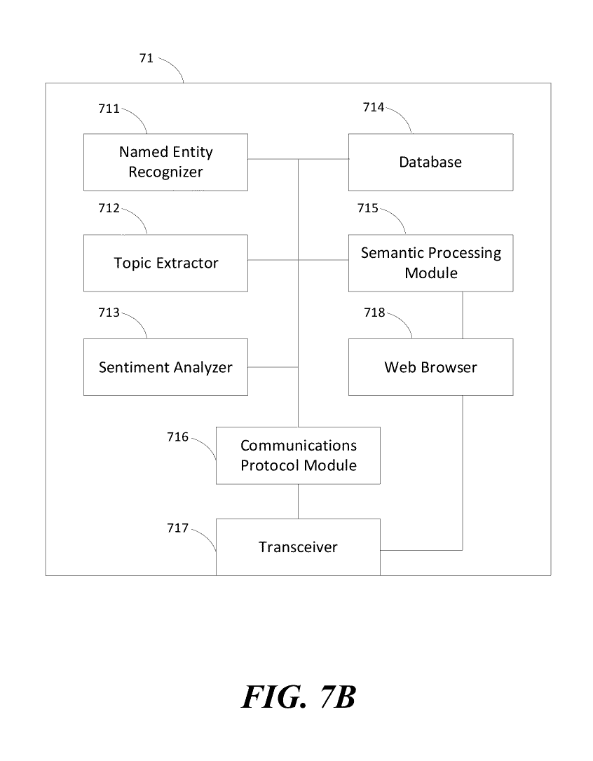

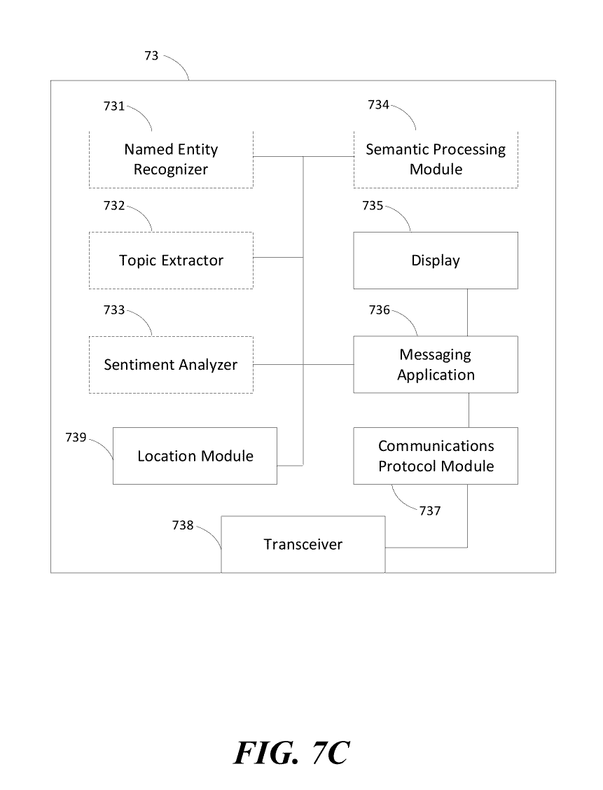

FIG. 7A shows a system that accommodates these various use cases, in accordance with one embodiment of the present invention. The system includes a server system 71, a data communication network 72 (such as the Internet, a LAN, a WAN, or similar data network), and a number of user terminals 73-76. The server system is described below in more detail in connection with FIG. 7B, while the user terminals are described below in more detail in connection with FIG. 7C. While FIG. 7A depicts the server system 71 as a single computer, it may be implemented as a number of computer servers that provide distributed processing (e.g. using a cloud computing model) using techniques known in the art. Moreover, while FIG. 7A depicts the user terminals 73-76 as smart phones, they may be implemented using other devices, and the scope of the invention is not limited to the example depiction shown.

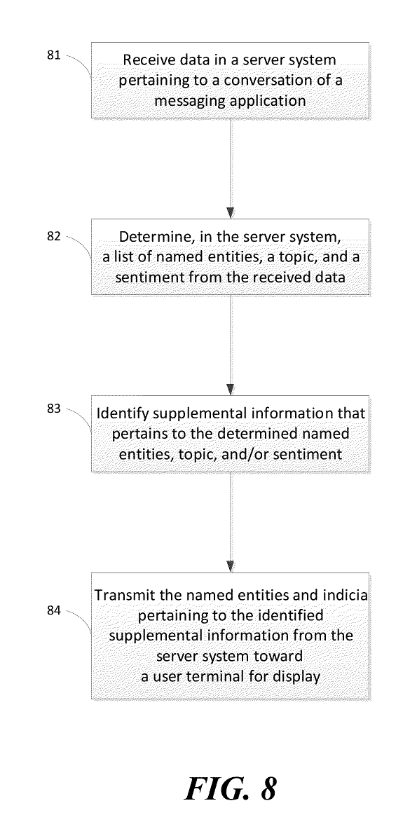

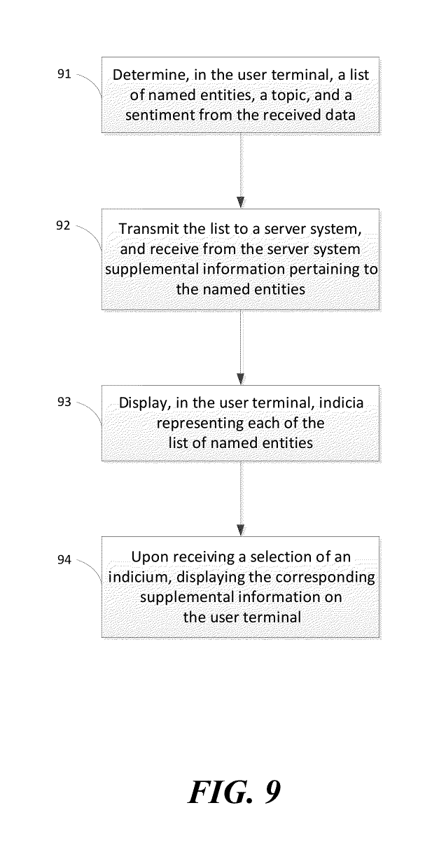

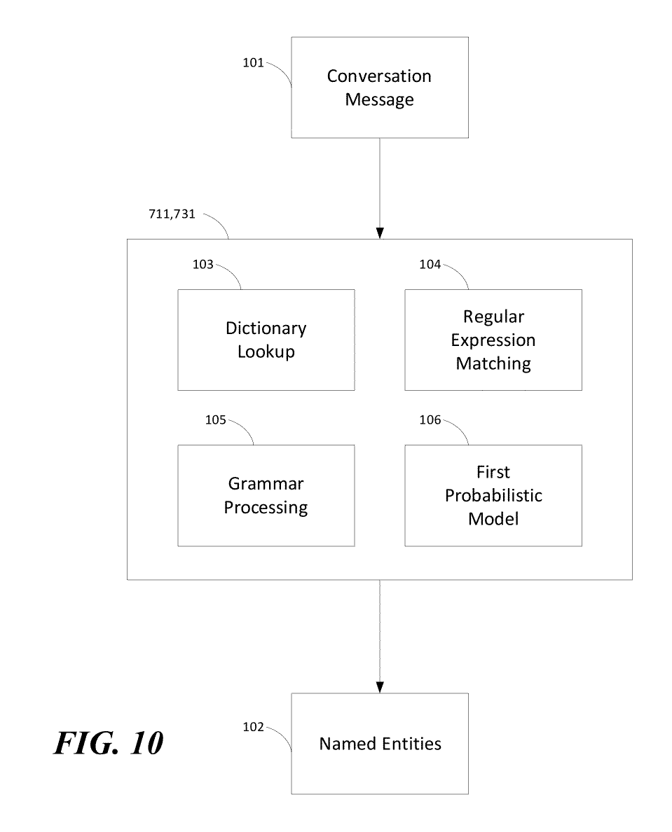

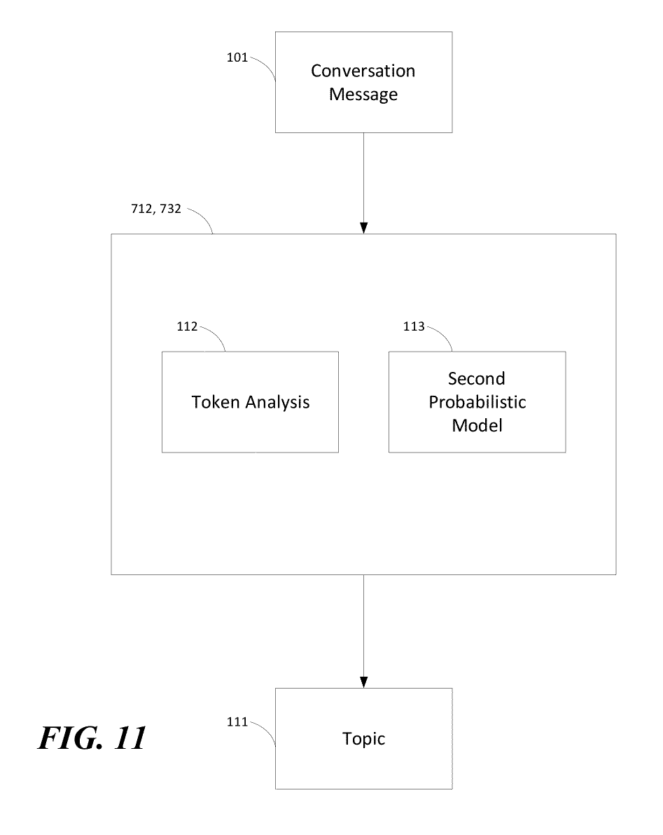

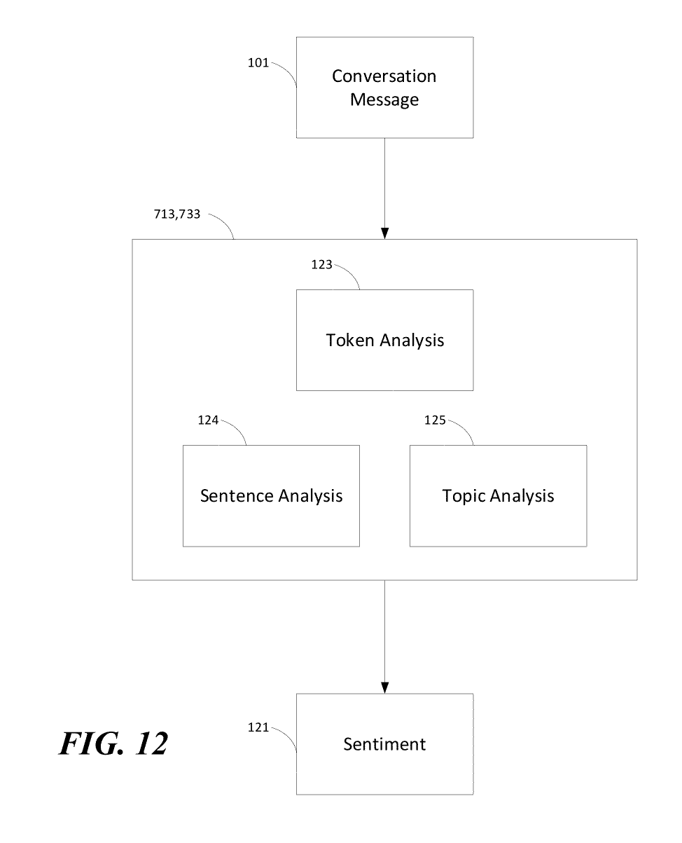

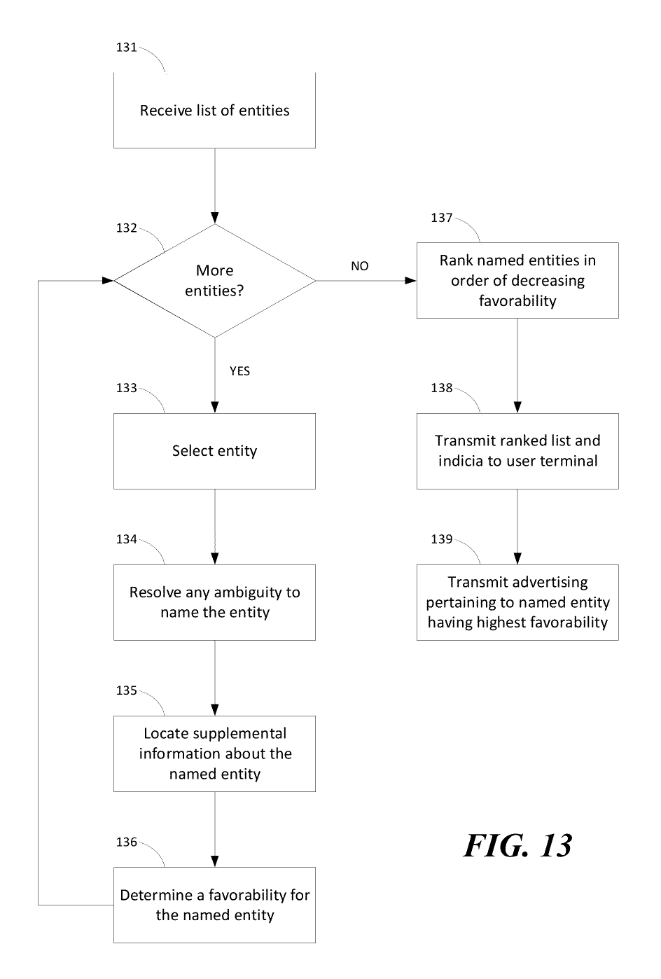

FIG. 7B shows the functional components of a server system embodiment in more detail. The server system 71 includes a named entity recognizer 711 that is capable of extracting named entities from conversations; the operation of the recognizer 711 is described below in more detail in connection with FIG. 10. The server system 71 also has a topic extractor 712 that is capable of extracting a topic from a conversation; its operation is described in connection with FIG. 11. The server system 71 has a sentiment analyzer 713 that is capable of determining a sentiment with respect to a given named entity or conversation; its operation is described in connection with FIG. 12. In some embodiments, topic extraction and sentiment analysis are more efficiently combined in a single process; this is discussed in connection with FIG. 13. The named entity recognizer 711, topic extractor 712, and sentiment analyzer 713 may perform their respective functions using data (for example, dictionaries or probability models) that are stored in a database 714. A semantic processing module 715 performs semantic processing of named entities, topics, and sentiments, and determines what supplemental information should be associated with the named entities, as described below in connection with FIG. 14. In some embodiments, such as that described below in connection with FIG. 8, the semantic processing module 715 receives data from the named entity recognizer 711, topic extractor 712, and sentiment analyzer 713. In other embodiments, such as that described below in connection with FIG. 9, the semantic processing module 715 receives named entities, topics, and sentiments directly from a user terminal. Communication between the server system 71 and the user terminal is facilitated by use of a communications protocol module 716 that processes formatted communications as is known in the art, and a transceiver 717 coupled to the communications protocol module 716 that may be, for example, a network data port. In order to locate certain supplemental information and determine its appropriateness, the server system 71 is provided with a web browser 718 that is directly coupled to the transceiver 717 and is controlled by the semantic processing module 715.

FIG. 7C shows the functional components of the user terminals of FIG. 7A in more detail. The user terminal 73 advantageously may, in some embodiments, optionally include a named entity recognizer 731, a topic extractor 732, a sentiment analyzer 733, and a semantic processing module 734 that are entirely analogous to those residing on the server system 71 described above. The user terminal 73 includes a display 735 on which may be displayed a GUI of a messaging application 736. The messaging application 736 is coupled to a communications protocol module 737 that complements a module found on the server system 71, so that the user terminal 73 and the server system 71 may effectively exchange data messages. The communications protocol module 737 is coupled to a transceiver 738 that may be, for example, a network data port. The messaging application 736 may use a location module 739, for example a GPS locator, wireless networking module, or other similar device, to obtain geographic location data for the user terminal 73. During typical operation, the messaging application 736 receives input from a user and displays a GUI (such as those shown in FIG. 2, 3, or 6) on the display 735, and communicates with other user terminals via a data communication network 72 to perform messaging functions.

The functional components of the server system 71 and the user terminal 73 depicted in FIGS. 7A-7C may be implemented using known hardware, for example conventional central processing units (CPU), random access memory (RAM), computer monitors, keyboards, mice, and other input devices, and so on. These components may operate cooperatively under the control of an operating system, as is known in the art.

FIG. 8 is a flowchart showing processes broadly relevant to implementing a method of transmitting contextual information, from a server system 71 toward a user terminal 73, in accordance with an embodiment of the invention. The method begins with the server system 71 receiving data pertaining to a conversation of a messaging application 736 in a first process 81. This process 81 may be implemented using standard data communication or networking techniques known in the art, using the communications protocol modules 716, 737 and transceivers 717, 738 described above. The data may be intact messages from one or more conversations that are stored by the messaging application 736, and may include location information obtained from the location module 739, time and date information pertaining to the messages, or other relevant data. The method continues in process 82 with named entity recognizer 711, topic extractor 712, and sentiment analyzer 713 determining from the conversation data one or more named entities, a topic, and a sentiment. Next, the server system 71, and more particularly the semantic processing module 715, executes a process 83 in which it identifies supplemental information that pertains to the determined named entities, topic, and/or sentiment. The method concludes in process 84, in which the server system 71 transmits indicia pertaining to the identified supplemental information toward the user terminal 73 for eventual display on the display 735.

FIG. 9 is a flowchart showing processes relevant to a user terminal 73 that is implementing a second embodiment of the invention. These processes are particularly useful for preserving the privacy of users, as will be explained. The method begins in a first process 91, in which the user terminal 71 determines, from data pertaining to a conversation of the messaging application, named entities, a topic, and a sentiment that each pertain to at least one message of the conversation. This process is executed using the named entity recognizer 731, topic extractor 732, sentiment analyzer 733, and semantic processing module 734 that are resident in the user terminal 73. Any sensitive information, such as credit card numbers, bank account numbers, social security numbers or the like may be removed by the user terminal 73 from the messages at this time, thereby preserving the privacy of the user's data.

Next, in process 92, the user terminal 73 transmits the named entities, topic, and sentiment to the server system 71, along with geographic data. The user terminal 73 then receives from the server system 71 indicia identifying supplemental information that pertains to the named entities. The server system 71 determines the supplemental information for each named entity as a function of the transmitted named entities, the topic, and the sentiment using the semantic processing module 715, but does not need to use the named entity recognizer 711, topic extractor 712, or sentiment analyzer 713. Then, in process 93, the user terminal 73 displays the indicia, in a selectable manner, on the display 735, under the direction of the messaging application 736. Finally, in process 94, upon receiving a selection of an indicium associated with the named entity using the graphical interface, the user terminal 73 displays the received supplemental information on the display 735.

The processes discussed in connection with FIGS. 8 and 9 are advantageously useful for displaying, in real time, indicia related to named entities that appear in an ongoing conversation. These processes also are useful for displaying indicia related to named entities that appear in one or more conversations that have occurred in the past. Other uses for these processes and this hardware and software may be apparent to a person having ordinary skill in the art, and the discussion of these exemplary use cases should not be viewed as limiting the scope of the invention.

FIG. 10 shows processes relevant to named entity recognition. Named entity recognition may be performed either in a server system 71 (more particularly, in recognizer 711) or in a user terminal 73 (more particularly, in recognizer 731), depending on the particular design needs of a given embodiment. The purpose of named entity recognition, in the context of the present disclosure, is to extract from one or more conversation messages 101 a collection of named entities 102. The named entity recognizer 711 may accomplish this task using any of a number of techniques known in the art to work on large server systems. In accordance with one particularly advantageous embodiment, these techniques may now be applied to a named entity recognizer 731 operating on a user terminal, which has significantly more limited resources.

In either case, a named entity recognizer may use any number of techniques to recognize named entities 102 in messages 101. These techniques include, in order of increasing complexity, a dictionary lookup 103, regular expression matching 104, grammar processing 105, and a probabilistic model 106. A dictionary lookup 103 simply matches words in a message 101 against named entities listed in a dictionary. The dictionary, which may be stored in the database 714 for example, may also contain references to supplemental information in case there is a match.

The named entity recognizer 711 or 731 also may employ regular expression matching 104. Unlike a dictionary lookup 103 that matches a message 101 against dictionary text, regular expression matching 104 matches a message 101 against a pattern. For example, if the symbol * indicates any character, then the pattern “*ing” matches all words that end in the letters I-N-G (in that order). As is known in the art, regular expression matching 104 may be used to extract currency amounts, dates, and other types of text that are not easily matched using a dictionary lookup 103. Some named entities 102 may be identified by the fact that they are proper nouns and therefore capitalized; a regular expression may be easily used to identify such named entities.

The named entity recognizer 711 or 731 also may employ grammar processing 105. In this process, the text of a message 101 is analyzed to determine parts of speech, such as verbs, adjectives, and (most importantly) nouns. Any noun (or phrase including a noun) that is detected may be an entity. If the noun or phrase uniquely identifies a concept, then it is a named entity 102. In accordance with some embodiments, non-named entities detected by the named entity recognizer may be further processed by a semantic processing module to resolve any ambiguities, as described below.

The named entity recognizer 711 or 731 also may employ a first probabilistic model 106, either as a standalone entity or in conjunction with grammar processing 105. The probabilistic model 106 is the result of training a machine learning algorithm to recognize words and phrases that are named entities. A lexical analyzer breaks each text message 101 into a sequence of tokens (for example, using dictionary lookups 103, regular expression matching 104, or grammar processing 105). The model 106 provides probabilities, as a function of the sequence of tokens, that any given token is an entity (or a named entity). Typically, the machine learning algorithm is trained on a large corpus of pre-classified text. That is, a large number of messages are tokenized, and the tokens are manually classified either as being named entities or not named entities. Statistical measures are derived from this analysis. As a simplistic example, the probability that a named entity in the corpus follows a non-named entity (versus another named entity) is determined. Later, when automatically applied to a message 101, this manually-derived measure provides a probability that an unknown token following a non-named entity is actually a named entity. Other, more complex measures known in the art that classify tokens, for example, by parts of speech, length, position in a sentence, date and time, geographic location, and other factors may be used in an embodiment of the invention. Advantageously, the machine learning algorithm itself does not need to be executed on a user terminal 73. Instead, in some embodiments, only the probabilities themselves are stored on the user terminal 73, resulting in a tremendous savings in computing cost and permitting the user terminal to perform named entity recognition directly.

FIG. 11 shows processes relevant to topic identification. Just as with individual tokens, entire messages 101 can be classified as pertaining to one topic 111 or another. Some messages 101 are highly structured. For example, TWITTER messages may include certain words or phrases, commonly known as “hashtags”, that are prefixed by a # symbol. Such textual markings may be strong indicators of the topic or topics of the message. Other messages may have similar, rigid structure that provides information about the topic of the message 101. Thus, a token analysis 112 may be used to search for such structure in the message 101 to identify the topic 111.

The topic extractor 712 or 732 also may employ a second probabilistic model 113. This probabilistic model 113 may be trained on messages in a manner similar to the first probabilistic model 106 is trained on tokens. Thus, the model 113 may store probabilities that if a previous message is known to pertain to topic X, that the current message 101 will pertain to topics X, Y, or Z. Given the underlying assumption that consecutive messages often related to the same topic, it should be clear that, given a first message 101 taken from a conversation, a second consecutive message 101 taken from the same conversation has a high probability of pertaining to the same topic 111. Thus, sequencing information (for example as determined by date and time data) relating to the messages 101 of a conversation often provides a strong clue as to the topic of each message 101 of the conversation. Once the model 113 has been established, it may be applied to unknown messages 101 to determine probabilistically whether they belong to any given topic. A particularly useful embodiment may store a model 113 that is limited to topics for which detailed supplemental information may be obtained, as described more fully below in connection with FIG. 14.

The second probabilistic model 113 may be trained automatically in a particularly advantageous way. As noted above, TWITTER messages often contain hashtags that provide a strong clue about the topic of the message. Moreover, there exists a large corpus of public TWITTER messages. Therefore, in a machine learning process that need not occur on the user terminal 73, hashtags are extracted from large numbers of TWITTER messages and used to classify them automatically. These automatic classifications are then used to form the second probability model 113. This technique may be applied only once, and the model 113 stored on the user terminal 73, or it may be applied on an ongoing basis by the server system 71, with the stored model 113 receiving periodic updates.

FIG. 12 shows processes relevant to sentiment analysis. In order to provide relevant supplemental information (including advertising), as described below in connection with FIG. 14, the server system 71 and/or the user terminal 73 are provided with sentiment analyzers 713, 733. The sentiment analyzer takes a conversation message 101 and produces, for each named entity, a sentiment 121 that may be positive, neutral, or negative to some degree. To provide the best user experience, the semantic processor may select the named entities having the highest favorability for display of supplemental information.

The sentiment analyzer 713, 733 may employ token analysis 123 to determine sentiment. Certain tokens are strongly indicative of sentiment. Emoticons or “smilies” are an example: if a message 101 contains a smiling emoticon, then the sentiment is likely favorable, while if the message 101 contains a frowning or crying emoticon, then the sentiment is likely negative. Once identified, the tokens of the message 101 therefore may be used to identify a sentiment.

In some situations, for example in complex messages that discuss multiple named entities, token analysis 123 is insufficient to determine the sentiments for each named entity. The sentiment analyzer 713, 733 therefore may employ sentence analysis 124 to determine sentiment. In particular, once a named entity has been identified, nearby tokens are more likely to provide information about the favorability of that named entity than distant tokens.

In other situations, a sentiment 102 expressed in a message 101 may pertain to the topic of the conversation. For this purpose, the sentiment analyzer 713, 733 may employ a topic analysis 125 to determine sentiment. A single sentiment 102 may be present with respect to a number of named entities, across multiple messages 101, that are related by a topic or classification. Topic analysis 125 correlates multiple messages 101 from the conversation to determine whether the topic itself is favorable or unfavorable.

Other techniques from natural language processing, computational linguistics, and textual analysis that are known in the art may be used to extract a sentiment 121 from a message 101, and the description of the above techniques should not be viewed as limiting the scope of the invention. Moreover, the techniques of named entity recognition, topic extraction, and sentiment analysis share many similarities, and may be efficiently combined in some embodiments into a single semantic engine.

FIG. 13 is a flowchart showing processes relevant to the determination of supplemental information in one embodiment. These processes are executed by the semantic processing module 715. The determination of supplemental information begins in a process 131 in which the semantic processing module 715 receives a list of entities. The list is obtained from a named entity recognizer 711 or 731 as the case may be.

In process 132 the module 715 determines whether there are more entities to be processed. If so, the method continues to process 133, in which one of the entities is selected for further processing. Next, in process 134, the module 715 resolves any ambiguity in the entity to provide it with a unique name. For example, “Frank” may be a given name, a surname, a group of people, a type of currency, a community in Alberta, the name of a girl band, the name of an album, a character in a comic strip, or a type of meat (among other things). If any entities have not been uniquely identified, they may be combined with information about the user, about the geographic location of the user terminal 73, about the date and time, about the topic of the conversation, or other information to resolve the ambiguity. For instance, if the topic of conversation is food, then “Frank” has a high probability of referring to a hot dog or similar food, rather than a comic strip.

In process 135, the module 715 locates supplemental information about the named entity. Continuing the previous example, the module 715 may engage the database 714 or the web browser 718 to locate information about hot dogs, such as nearby restaurants that offer this food on their menus, a WIKIPEDIA page that describes hot dogs, or advertising by hot dog makers. The server system 71 may be provided with various application programming interfaces (APIs) that can retrieve this information from knowledgeable sources. APIs may provide, for instance, access to a web document, the WIKIPEDIA web site or other repositories of information such as DBPEDIA, a search suggestion for a web search engine such as GOOGLE, movie listings such as those found at NETFLIX or movie information found at IMDB, sports scores at ESPN, listings for local businesses through the YELLOW PAGES, weather information, product information, audiovisual presentation such as POWERPOINT presentations, advertising, or other sources of supplemental information.

In process 136, the module 715 determines a favorability for the named entry. This favorability may be obtained through the sentiment analyzer 713 or 733. It should be noted that different users may have different sentiments with respect to the same named entities, so this process 136 may produce different results depending on the user to which it is applied. Thus, in some embodiments the module 715 determines a favorability for the given named entity with respect to each user that is participating in the conversation. Once this process 136 is complete, the method returns to process 132 in which it is determined whether there are more entities to process.

Once all entities in a message has been analyzed and supplemental information located, the module 715 proceeds to process 137 in which it ranks the named entities in order of decreasing favorability. When the named entities have been ranked, the server system 71 transmits the ranked list, and indicia pertaining to the named entities, toward the user terminal 73 for eventual display. The indicia themselves may be, for example, text strings that have associated URLs. For example, the named entity “Frank” (once properly disambiguated to mean a hot dog) may be associated with a URL for a WIKIPEDIA page that describes hot dogs. These data are sent to the user terminal 73, which displays the word “Frank” in an appropriate part of its GUI. Upon selection of the indicium, the URL is accessed and the supplemental information displayed. Optionally, the server system 71 also transmits advertising pertaining to a named entity in process 139 for display in the GUI. Preferably, this named entity has the highest favorability of all detected named entities, so the advertising is as relevant as possible to the user's interests. As noted above, different users may have different sentiments with respect to the same named entities, so the advertisement that each user sees may be different, as illustrated in FIG. 4.

Various embodiments of this invention have been described. However, this disclosure should not be deemed to be a limitation on the scope of the invention. Accordingly, various modifications, adaptations, and alternatives may occur to one skilled in the art without departing from the spirit and scope of the claimed invention.

It should be noted that the logic flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

What is claimed is:

1. A computerized method of transmitting contextual information, from a server system toward a user terminal, the user terminal executing a messaging application having a graphical user interface, the method comprising:
in a first computer process, determining, from data pertaining to a conversation of the messaging application, a named entity, a topic, and a sentiment that each pertain to at least one message of the conversation;
in a second computer process, identifying supplemental information that pertains to a combination of one or more of the determined named entity, topic, and sentiment; and
in a third computer process, transmitting the named entity and indicia pertaining to the identified supplemental information, from the server system toward the user terminal for display of the indicia on the user terminal by the messaging application using the graphical interface.

2. The method according to claim 1, wherein the user terminal is a smart phone, a personal digital assistant, a tablet computer, or a laptop computer.

3. The method according to claim 1, wherein the messaging application comprises a bulletin board application, an email application, an instant messaging application, or an SMS application.

4. The method according to claim 1, wherein determining the named entity comprises using one or more of a dictionary search, a regular expression match, and a first probabilistic model derived from a first machine learning algorithm.

5. The method according to claim 1, wherein the topic and sentiment are determined simultaneously using a second probabilistic model derived from a second machine learning algorithm.

6. The method according to claim 5, wherein the second machine learning algorithm is trained using a corpus of publicly-available messages that each identify a topic and a sentiment, respectively, using textual markings.

7. The method according to claim 6, wherein the corpus comprises TWITTER messages, the topic textual markings comprise hashtags, and the sentiment textual markings comprise emoticons.

8. The method according to claim 1, wherein the supplemental information comprises a web document, a wild article, a search suggestion, a movie listing, a sports score, information pertaining to a local business, weather information, product information, an audiovisual presentation, or an advertisement.

9. A computerized method of displaying contextual information on a user terminal executing a messaging application having a graphical user interface, the method comprising:
in a first computer process, determining, from data pertaining to a conversation of the messaging application, a named entity, a topic, and a sentiment that each pertain to at least one message of the conversation;
in a second computer process, transmitting the determined named entity, topic, and sentiment to a server system, and receiving from the server system indicia identifying supplemental information that pertains to the determined named entity, the server system having determined the supplemental information as a function of the transmitted named entity, the topic, and the sentiment;
in a third computer process, displaying the indicia on a display of the user terminal, by the messaging application using the graphical interface; and
in a fourth computer process, upon receiving a selection of an indicium associated with the named entity using the graphical interface, displaying the received supplemental information on the display of the user terminal, by the messaging application using the graphical interface.

10. The method according to claim 9, wherein the user terminal is a smart phone, a personal digital assistant, a tablet computer, or a laptop computer.

11. The method according to claim 9, wherein the messaging application comprises a bulletin board application, an email application, an instant messaging application, or an SMS application.

12. The method according to claim 9, wherein determining the named entity comprises using one or more of a dictionary search, a regular expression match, and a first probabilistic model derived from a first machine learning algorithm.

13. The method according to claim 12, wherein the first probabilistic model is stored on the user terminal for use by the first computer process.

14. The method according to claim 9, wherein the topic and sentiment are determined simultaneously using a second probabilistic model derived from a second machine learning algorithm.

15. The method according to claim 14, wherein the second probabilistic model is stored on the user terminal for use by the first computer process.

16. The method according to claim 14, wherein the second machine learning algorithm is trained using a corpus of publicly-available messages that each identify a topic and a sentiment, respectively, using textual markings.

17. The method according to claim 16, wherein the corpus comprises TWITTER messages, the topic textual markings comprise hashtags, and the sentiment textual markings comprise emoticons.

18. The method according to claim 9, wherein the supplemental information comprises a web document, a wild article, a search suggestion, a movie listing, a sports score, information pertaining to a local business, weather information, product information, an audiovisual presentation, or advertising.

19. The method according to claim 18, wherein the indicia include at least one indicium comprising a text string that is associated with a URL.

20. The method according to claim 19, further comprising:
receiving a selection of the text string using the graphical interface; and
displaying, on the user terminal, data retrieved from the URL.
